(19) United States
(12) Patent Application Publication
(10) Pub. No.: US 2007/0189383 A1
(43) Pub. Date: Aug. 16, 2007

(54) Method and system for appending redundancy to uncompressed video for transmission over wireless communication channels

(75) Inventors: Huai-Rong Shao, San Jose, CA (US); Harkirat Singh, Santa Clara, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/635,970

(22) Filed: Dec. 7, 2006

Related U.S. Application Data
(60) Provisional application No. 60/773,976, filed on Feb. 15, 2006.

(51) Int. Cl. H04N 7/12; H04N 11/04; H04N 11/02; H04B 1/66

(52) U.S. Cl. 375/240.12; 375/240.26; 375/240.27; 348/384.1

(57) ABSTRACT

A method and system for communication of uncompressed video information over a wireless channel, involving partitioning neighboring pixels in a video frame into different packets and transmitting the packets separately over a wireless channel. Redundancy information is generated for pixels in one or more packets and transmitted over the wireless channel. In case of packet loss or damage, the redundancy information can be used to recover the pixels in the lost or erroneous packet. The redundancy information can be transmitted to a receiver on a different channel than said packets. The redundancy information can be transmitted in one or more packets among the original pixel data packets.

### RELATED APPLICATION

This application claims priority from U.S. Provisional Patent Application Ser. No. 60/773,976, filed on Feb. 15, 2006, incorporated herein by reference.

### FIELD OF THE INVENTION

The present invention relates to wireless communications, and in particular, to transmission of uncompressed video over wireless communication channels.

### BACKGROUND OF THE INVENTION

With the proliferation of high quality video, an increasing number of electronic devices (e.g., consumer electronic devices) utilize high-definition (HD) video. Conventionally, most devices compress the HD video, which can be around 1 Gbps (gigabits per second) in bandwidth, to a fraction of its size to allow for transmission between devices. However, with each compression and subsequent decompression of the video, some video information can be lost and the picture quality is degraded.

The High-Definition Multimedia Interface (HDMI) specification defines an interface for uncompressed HD transmission between devices through the HDMI cables (wired links). Three separate channels are used to transmit three component streams (R, G, B or Y, Cb, Cr). For each channel, pixels are transmitted in pixel-by-pixel order for each video line, and line-by-line for each video frame or field. The HDMI provides pixel-repetition functionality which repeats each pixel one or multiple times. The copies of each pixel directly follow the original pixel during the transmission at each component channel.

Existing Wireless Local Area Networks (WLANs) and similar technologies do not have the bandwidth needed to carry uncompressed HD video, such as providing an air interface to transmit uncompressed video over a 60 GHz bandwidth. Further, existing WLANs can suffer from interference issues when several devices are connected, leading to video signal degradation.

### BRIEF SUMMARY OF THE INVENTION

The present invention provides a method and a system for appending redundancy to uncompressed video for transmission over wireless channels. In one embodiment, the present invention provides a method and a system for spatial video pixel partitioning, and then appending redundancy information, for transmission of uncompressed video from a transmitter to a receiver over a wireless channel.

According to said embodiment of the present invention, neighboring pixels in a video frame are partitioned into different packets and transmitted separately over a wireless channel from a transmitter to a receiver. Further, redundant information for the partitioned and packetized video pixels is transmitted from the transmitter to the receiver to improve the transmission robustness. In case of packet loss or damage, the redundancy information can be used to recover the pixels in the lost or erroneous packet. The redundancy information can be transmitted to a receiver on a different channel than said packets. In one example, the redundancy information is transmitted in one or more packets among the original pixel data packets.

In addition, the packets carrying the neighboring pixels can be used to recover the pixels in the corrupt packet. As such, retransmission of lost information is not required, which saves transmission bandwidth.

These and other features, aspects and advantages of the present invention will become understood with reference to the following description, appended claims and accompanying figures.

### BRIEF DESCRIPTION OF THE DRAWINGS

FIG. 1 shows an example of partitioning video pixels into packets and appending partial redundancy information to enhance packet transmission reliability, according to an embodiment of the present invention.

FIG. 2 shows an example of appending the average value of four pixel partitions as redundancy information to enhance transmission reliability, according to an embodiment of the present invention.

FIG. 3 shows an example of appending redundancy after differential pulse code modulation (DPCM) encoding or binary XOR (bXOR) encoding, according to an embodiment of the present invention.

FIG. 4 shows an example of DPCM (or bXOR) encoding and Run-Length coding (RLC) for DIFF pixels and saved bits used to protect BASE pixels, according to an embodiment of the present invention.

FIG. 5 shows an example format of a packet for transmitting video information, according to an embodiment of the present invention.

FIG. 6 shows a functional block diagram of an example communication system implementing spatial pixel partitioning, encoding and redundancy appending, for transmission of uncompressed HD video over a wireless medium, according to an embodiment of the present invention.

FIG. 7 shows a flowchart of an embodiment of a process for processing packets received at a receiver in the system of FIG. 6, according to an embodiment of the present invention.

In the drawings, like references refer to similar elements.

### DETAILED DESCRIPTION OF THE INVENTION

The present invention provides a method and a system for appending redundancy to uncompressed video for transmission over wireless channels. In one embodiment, the present invention provides a method and a system for spatial video pixel partitioning, and then appending redundancy information, for transmission of uncompressed HD video from a transmitter to a receiver over a wireless channel.

There are two categories of HD video formats according to a display scan scheme: interlaced and progressive. In the progressive scheme, the pixels are scanned line-by-line. In the interlaced scheme, the pixels are scanned every other line and one video frame is divided into two sub-frames called odd line field and even line field. In each video frame, usually the neighboring pixels have very similar or even the same values. This type of spatial redundancy can be used in wireless transmission to improve video quality.

According to said embodiment of the present invention, neighboring pixels in a video frame are partitioned into different packets and transmitted separately over wireless channels from a transmitter to a receiver. Further, redundant information for the partitioned and packetized video pixels is transmitted from the transmitter to the receiver to improve the transmission robustness. In case of packet loss or damage, the redundancy information can be used to recover the pixels in the lost or erroneous packet. The redundancy information can be transmitted to a receiver on a different channel than said packets.

In one example, the redundancy information is transmitted in one or more packets among the original pixel data packets. As such, each packet header includes information (e.g., one or more bits) to indicate that the packet carries original pixel data or redundancy information. Packet size is selected depending on transmitter and receiver buffer requirements. One or more lines worth of pixels can be placed in each packet.

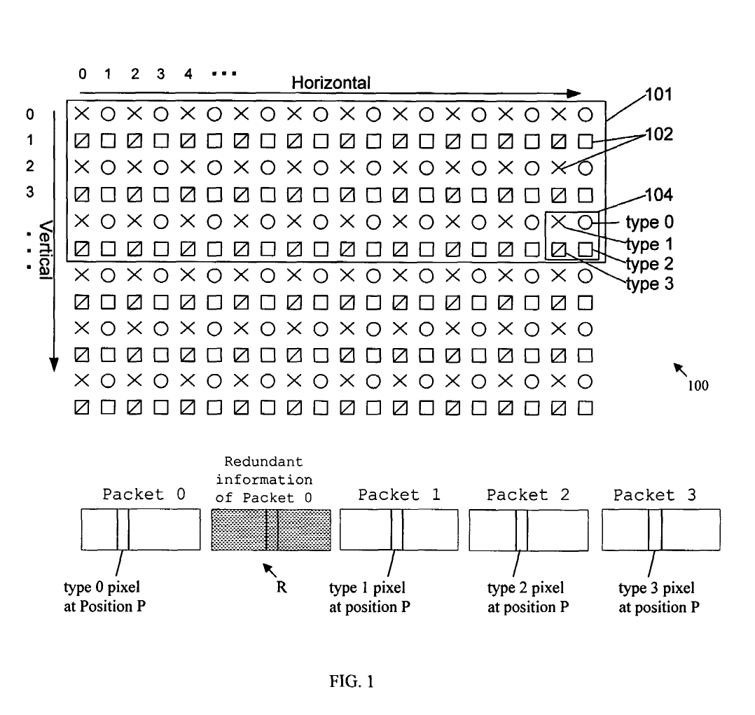

FIG. 1 shows an example of partitioning an uncompressed video frame 100 into K=4 partitions, and then adding a redundancy packet including redundancy information, according to said embodiment of the present invention. The uncompressed video frame 100 includes a set 101 of pixels 102. The spatial location of each pixel 102 in the frame 100 can be identified by a column index i (horizontal), and a row index j (vertical). Each of the indices i and j can take on integer values 0, 1, 2, 3, 4, etc. In this example, the pixels are split into four types (i.e., types 0, 1, 2, 3) of 2×2 blocks 104, wherein K=4 pixels per block. The four pixels in each 2×2 block 104 are placed into 4 different packets (i.e., Packets 0, 1, 2, 3) as shown. Pixels with minimal spatial distance are placed into different packets for transmission.

Specifically, for the type 0 pixels, the indices i and j are even numbers (i.e., i=0, 2, 4, . . . , etc., and j=0, 2, 4, . . . , etc.), and the type 0 pixels are placed in the Packet 0. For the type 1 pixels, the index i is odd (i.e., i=1, 3, 5, . . . , etc.), the index j is even (i.e., j=0, 2, 4, . . . , etc.), and the type 1 pixels are placed in the Packet 1. For the type 2 pixels, the index i is even (i.e., i=0, 2, 4, . . . , etc.), the index j is odd (i.e., j=1, 3, 5, etc.), and the type 2 pixels are placed in the Packet 2. For the type 3 pixels, the indices i and j are odd numbers (i.e., i=1, 3, 5, . . . , etc., and j=1, 3, 5, . . . , etc.), and the type 3 pixels are placed in the Packet 3.

Then, redundancy information, such as one or more pixels in every K pixels, or an average value of every K pixels, or other redundancy information, is included as redundant information in one or more packets. Other examples of redundancy information include selected pixels of each packet, or the average values for every K=4 pixel blocks (one pixel from each packet), Forward Error Correction (FEC) information, etc. If FEC is used for generating redundancy information, then FEC information for the pixels of one particular type (e.g., type 0, 1, 2, 3) can be added as redundant information.

FIG. 1 shows a packet R in which redundant information for Packet 0 is stored. Such redundancy information can comprise, e.g., a copy of the pixel in Packet 0, the FEC information of the pixels of Packet 0, etc.

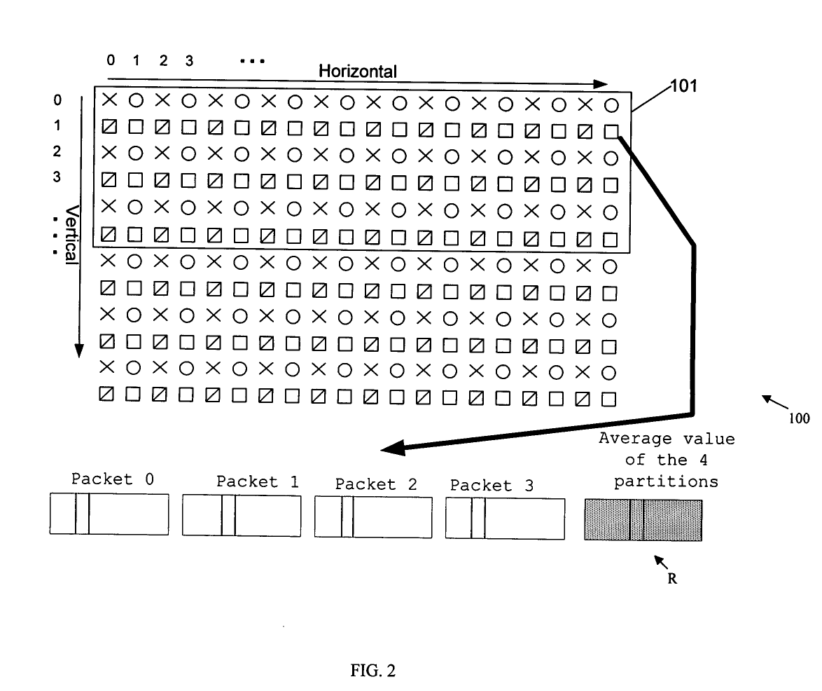

FIG. 2 illustrates another example wherein the pixels are partitioned into K=4 partitions as in FIG. 1. However, unlike FIG. 1 wherein appended redundancy information packet R includes the redundancy information for one particular packet (i.e., Packet 0), in the example in FIG. 2, the appended redundancy information packet R carries the average value of pixels in the Packets 0, 1, 2 and 3. As such, if information in only one packet is lost/damaged, that information can be correctly recovered using the redundancy packet R and the other three packets.

According to further embodiments of the present invention, after partitioning the pixels in a set 101 into K partitions, instead of placing all of the original video pixel information into packets, the value of the n^{th} fixed position pixel is selected at every K pixel block as base information (n<K), and information of other pixels in the block is encoded within the same block (e.g., by using DPCM or bXOR encoding). The encoded pixels are termed DIFF pixels and transmitted in DIFF packets, and the pixels carrying the original video data are termed BASE pixels and transmitted in BASE packets. Because spatially correlated pixels usually have very similar or even the same values, after DPCM or bXOR encoding, the Most Significant Bits (MSBs) of the DIFF pixels are mostly zero. In order to conserve transmission bandwidth, the zero bits need not be transmitted. Two example implementations of such an approach are hard truncation and RLC as described below.

According to further embodiments of the present invention, a lesser number of bits can be used to represent DIFF pixels than BASE pixels by truncating the high order zero bits (i.e. truncating the high order zero bits of the DIFF pixels). The saved DIFF bits are used to carry some MSB information or FEC information of the corresponding BASE pixels.

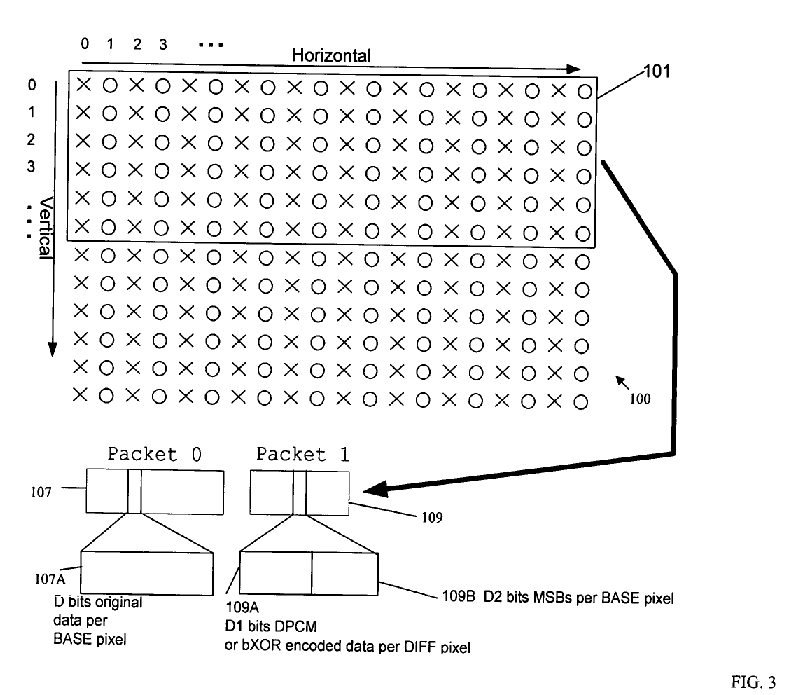

According to further embodiments of the present invention, redundancy information is appended after DPCM or bXOR encoding. FIG. 3 shows an example of appending redundancy after DPCM or bXOR encoding (K=2 packet partitions), according to an embodiment of the present invention. In FIG. 3 the pixels are split horizontally into two groups: the first group of pixels have index i=0, 2, 4, . . . , etc., and index j=0, 1, 2, . . . , etc.; and the second group of pixels have index i=1, 3, 5, . . . , etc., and index j=0, 1, 2, . . . , etc.

Each pixel comprises D bits. A first packet 107 (i.e., Packet 0) includes D bits 107A of the original data per pixel for said first group of pixels (BASE pixels). The first packet 107 is an example of a BASE packet.

For a DIFF pixel, D1 bits are used for DPCM or bXOR compressed data and D2 bits are used to carry some MSB information or FEC information of the BASE pixel, wherein D=D1+D2. As such, a second packet 109 (i.e., Packet 1) includes: D1 bits 109A for said second group of pixels that are DPCM or bXOR encoded per pixel (DIFF pixels), and D2 bits 109B of MSBs per BASE pixel. The second packet 109 is an example of a DIFF packet.

The determination of D1 and D2 is made in advance according to video content types, and D1 and D2 remain fixed throughout the transmission. For example, if the number of partitions K=2, D=24 and D1=D2=12, then for each DIFF pixel, 12 bits are used for a DPCM value and the other 12 bits are used for redundancy information of the corresponding BASE pixel.

If there are multiple DIFF pixels for one block (K>2), then multiple D2 bits from different DIFF pixels can be combined together to provide the BASE pixel with improved redundancy protection. For example, if K=4, D=24, and D1=D2=12, then for each DIFF pixel, 12 bits are used for a DPCM or a bXOR value and the other 12 bits are used for redundancy information of the corresponding BASE pixel. Since when K=4 there are three DIFF pixels in each block, a total of 36 bits can be used to protect the BASE pixel.

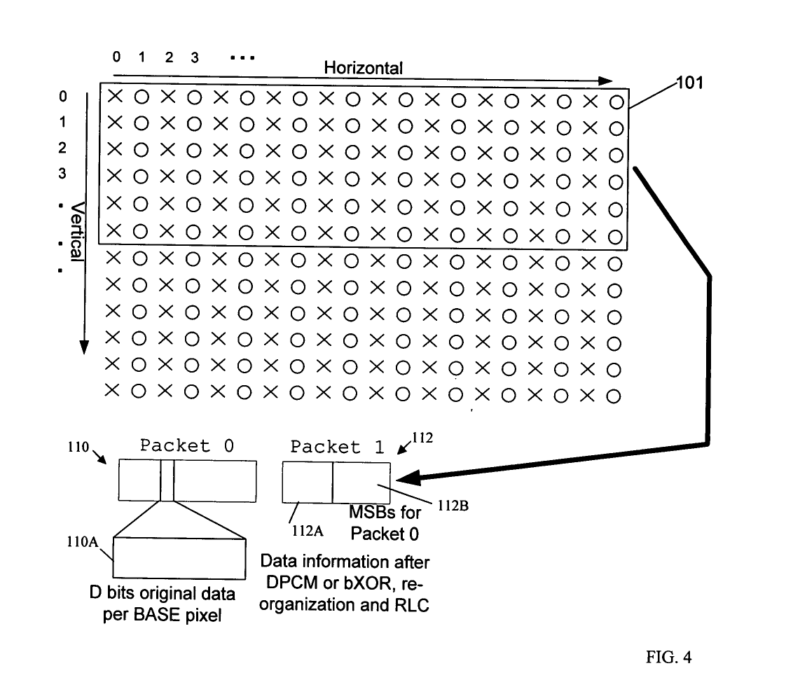

FIG. 4 illustrates another example wherein the saved bits in a DIFF packet are used to append redundancy information for the corresponding BASE packet. FIG. 4 shows an example of K=2 partitioning, and further appending redundancy after RLC, including DPCM (or bXOR) and RLC coding for DIFF pixels, wherein saved DIFF bits 112B are used to protect BASE pixels, as described below.

The pixels in FIG. 4 are split horizontally into two groups: the first group of pixels has index i=0, 2, 4, and index j=0, 1, 2, . . . , etc.; and the second group of pixels has index i=1, 3, 5, . . . , etc., and index j=0, 1, 2, . . . , etc. A first packet 110 (i.e., Packet 0) is constructed which includes D bits 110A of the original data per pixel from said first group of pixels (BASE pixels). The first packet 110 is another example of a BASE packet. A second packet 112 (i.e., Packet 1) is constructed which includes data information after DPCM or bXOR encoding, re-organization and RLC, per pixel from said second group of pixels. Compared to FIG. 3, in FIG. 4 no truncation of higher order bits is used, instead, DPCM or bXOR encoding, re-organization and the RLC approach is used to reduce the size of the packet. After DPCM or bXOR, mostly the higher order bits of each R (or G, or B) component of each pixel are “0”. However, in the bit-stream, “0”s and “1”s are interlaced. Bit-reorganization is applied to bit orders to generate a bit-stream wherein in the bit stream similar bits are grouped together (e.g., continuous “0” bits grouped together). Then RLC can compress the bitstream greatly. The packet 112 has a part 112A wherein data information after DPCM or bXOR, reorganization and RLC are stored, and a second part 112B where MSBs of the first packet 110 (Packet 0) are stored.

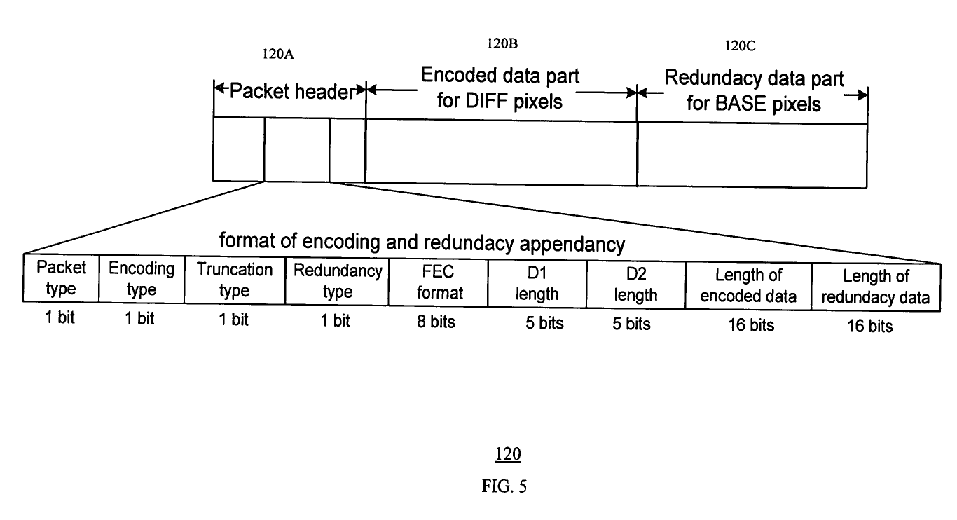

FIG. 5 shows the format of an example packet format 120 that can function as a BASE packet or as a DIFF packet based on settings in a packet header field 120A. As shown in FIG. 5, the packet header field 120A of the packet 120 includes several subfields related to encoding and redundancy appendance, according to the present invention, which are described in Table 1 below.

TABLE 1

| | Length | | |
|---|---|---|---|
| Subfield | (bits) | Meaning | Definition |
| Packet type | 1 | BASE packet or DIFF packet | 0: BASE packet |
| | | | 1: DIFF packet |
| Encoding type | 1 | DPCM or bXOR | 0: DPCM |
| | | | 1: bXOR |
| Truncation type | 1 | Hard truncation or RLC coding | 0: Hard truncation |
| | | | 1: RLC coding |
| Redundancy type | 1 | Copy of the BASE pixel data or FEC | 0: Copy of the BASE |
| | | information | pixel data |
| | | | 1: FEC information |
| FEC format | 2 | FEC format used | 00: (32, 24) |
| | | | Others: Reserved |
| D1 length | 5 | Length of the D1 | 0~32 |
| D2 length | 5 | Length of the D2 | 0~32 |
| Length of encoded data | 16 | Length of the encoded content data | 0~64 Kbytes |
| Length of redundancy | 16 | Length of the redundancy content | 0~64 Kbytes |
| data | | data | |

The Packet type subfield of the packet header field 120A indicates if the packet 120 is a BASE packet which carries original base pixels, or a DIFF packet. When the Packet type subfield indicates that the packet 120 is a DIFF packet, then an encoded data part field 120B of the packet 120 carries DIFF pixels, and a redundancy data part field of the packet 120C carries redundancy information (e.g., MSBs) for BASE pixels in a corresponding BASE packet. The packet 112 in FIG. 4 is a version of the packet 120 in FIG. 5 when the Packet type subfield of the packet header field 120A indicates that the packet 120 is a DIFF packet. When the Packet type subfield of the packet header field 120A indicates that the packet 120 is a BASE packet, the fields 120B and 120C of the packet 120 are collectively used to carry BASE pixels.

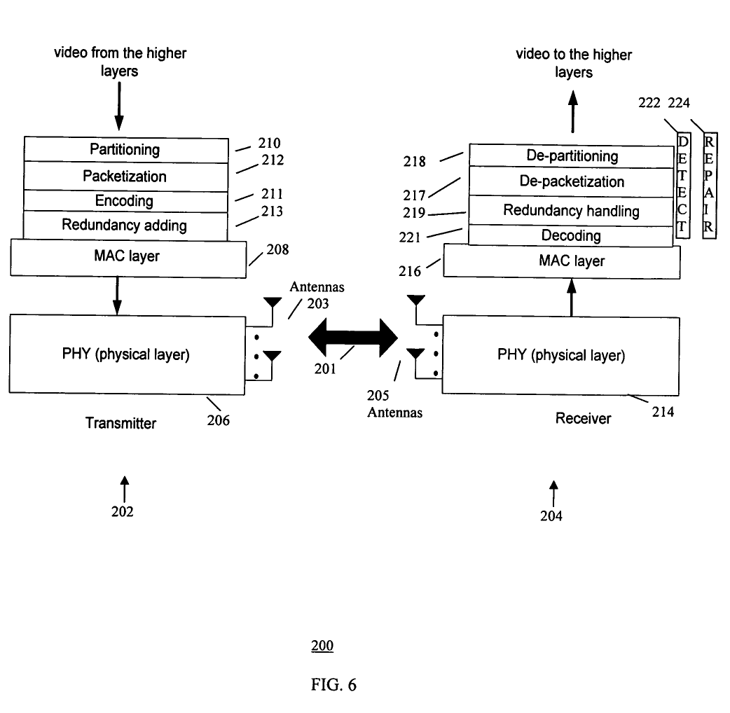

FIG. 6 shows a functional block diagram of an example wireless communication system 200, according to an embodiment of the present invention. The system 200 includes a wireless transmitter 202 and a wireless receiver 204. The transmitter 202 includes a physical (PHY) layer 206 and a MAC layer 208. Similarly, the receiver 204 includes a PHY layer 214 and a MAC layer 216. The PHY and MAC layers enable wireless communication between the transmitter 202 and the receiver 204 via transmit antennas 203 and receiver antennas 205, respectively, over a wireless channel 201.

The transmitter 202 further includes a partitioning module 210, a packetization module 212, an encoding module 211, and a redundancy adding module 213. The partitioning module 210 receives video frames and implements the above pixel partitioning steps on uncompressed video from higher levels, and the packetization module 212 generates packets of data from the partitioned pixels.

The encoding module 211 performs encoding (e.g. DPCM, bXOR, etc.) and the redundancy adding module 213 adds redundancy as described above, according to the present invention. The MAC layer 208 converts each packet into a MAC packet by adding a MAC header to each data packet, and further calculates and adds Cyclic Redundancy Code (CRC) information to the packets. The MAC packets are then provided to the PHY layer 206. The PHY layer 206 adds a PHY header to each MAC packet for transmission to the receiver 204 via transmit antennas 203.

In the receiver 204, the PHY layer 214 receives the transmitted packets. The MAC layer 216 processes each received packet. The receiver 204 further includes a decoding module 221, a redundancy handling module 219, a de-packetization module 217 and a de-partitioning module 218.

The decoding module 221 receives the processed packets from the MAC layer 216, and performs inverse steps of the encoding module 211. Then, the redundancy handling module 219 extracts redundancy information from the packets that include redundancy information (e.g., based on packet header) for recovering lost/damaged pixel information.

The de-packetization module 217 provides the bits in the packets to the de-partitioning module 218. The de-partitioning module 218 performs an inverse partitioning method of the partitioning module 210 to regenerate the uncompressed video from the partitioned pixels in the packets. The modules 210, 211, 212 and 213 can be components of the MAC layer 208 or Application layer. Similarly, the modules 217, 218, 219 and 221 can be components of the MAC layer 216 or Application layer.

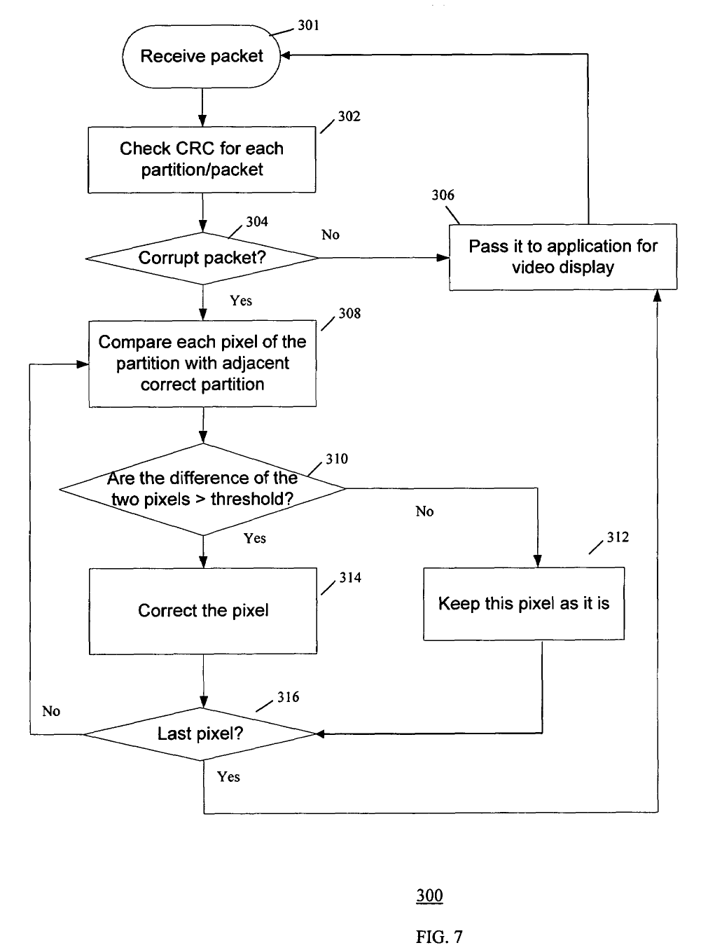

The receiver 204 further includes an error detection module 222 and a repair (correction) module 224. The error detection module 222 detects lost or damaged pixels in packets (e.g. using CRC information). The repair module 224 utilizes the redundancy information obtained by the redundancy handling module 219, to compensate for the lost or damaged pixel as described, when the de-partitioning module 218 performs said inverse partitioning steps. In one example, the detection module 222 and a repair module 224 perform the process 300 in the flowchart of FIG. 7, including the steps of:
Step 301: Receive a packet.
Step 302: Check the CRC for a received packet.
Step 304: Based on the CRC, determine if the packet is corrupt (i.e., lost or erroneous pixel values). If not, go to step 306, otherwise go to step 308.
Step 306: Pass the received packet to higher levels for display. Go to step 301 to process the next packet.
Step 308: Determine a difference between each pixel in the corrupt packet with a corresponding pixel of an adjacent non-corrupt packet.
Step 310: Determine if the difference is greater than a threshold. If not, go to step 312, otherwise go to step 314.
Step 312: Retain the pixel. Go to step 316.
Step 314: Correct the pixel using corresponding redundancy information. Correction of the pixels depends on the type of redundancy information.
Step 316: Determine if any other pixels remain in the corrupt packet for processing. If not, go to step 318, otherwise go back to step 306.

Each received packet is processed according to the above steps for error detection and recovery. As noted in Step 314, recovery (correction) of the pixels depends on the type of redundancy information. In one example, where the corresponding redundancy information for a pixel comprises a copy of said pixel, recovering a corrupt pixel comprises copying a pixel from the corresponding redundancy information in place of the corrupt pixel. In another example, where the corresponding redundancy information for a pixel comprises an average value of a pixel and neighboring pixels, then recovering a corrupt pixel comprises using the average value from the corresponding redundancy information in place of the corrupt pixel information. Yet in another example, where the corresponding redundancy information for a pixel comprises FEC information for the pixel, then recovering a corrupt pixel comprises using the FEC information from the corresponding redundancy information to compensate for the corrupted pixel. As those skilled in the art will recognize, other examples of redundancy information for recovering corrupt pixels are possible.

The repair module 224 can further utilize information from neighboring pixels, to compensate for lost or damaged pixels in step 314. If one packet is received corrupted (i.e., the pixels lost or are received with errors), then the packets carrying the neighboring pixels are used to recover the pixels in the corrupt packet. As such, retransmission of lost information is not required, which saves transmission bandwidth. In one example (e.g., K=2 partitions), correcting the pixel includes recovering the pixel in the corrupt packet using a corresponding pixel of the adjacent non-corrupt packet. In another example (K=4 partitions), correcting a corrupt pixel includes replacing the pixel in the corrupt packet with a combination of the neighboring pixels of an adjacent non-corrupted packet.

As is known to those skilled in the art, the aforementioned example architectures described above, according to the present invention, can be implemented in many ways, such as program instructions for execution by a processor, as logic circuits, as an ASIC, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of transmitting uncompressed video over a wireless channel, comprising the steps of:
inputting a frame of uncompressed pixel information;
partitioning spatially correlated pixels into different partitions;
placing pixels from different partitions into different packets;
determining corresponding redundancy information for one or more of the partitioned pixels based on spatially correlated pixels; and
transmitting each packet and the redundancy information over a wireless channel.

2. The method of claim 1, wherein the step of partitioning includes the step of partitioning neighboring pixels into different partitions.

3. The method of claim 1, wherein the redundancy information comprises a copy of said one or more pixels.

4. The method of claim 1, wherein the redundancy information comprises FEC information of one or more pixels.

5. The method of claim 1, wherein the redundancy information is transmitted to a receiver on a different channel than said packets.

6. The method of claim 1, further comprising the steps of:
receiving one or more packets and said corresponding redundancy information;
checking if a received packet is corrupt; and
recovering a corrupt pixel in a corrupt packet using the corresponding redundancy information.

7. The method of claim 6, wherein the corresponding redundancy information for a pixel comprises a copy of said pixel, such that the step of recovering a corrupt pixel comprises copying a pixel from the corresponding redundancy information in place of the corrupt pixel.

8. The method of claim 6, wherein the corresponding redundancy information for a pixel comprises an average value of said pixel and neighboring pixels, such that the step of recovering a corrupt pixel comprises using the average value from the corresponding redundancy information in place of the corrupt pixel information.

9. The method of claim 6, wherein the corresponding redundancy information for a pixel comprises FEC information for the pixel, such that the step of recovering a corrupt pixel comprises using the FEC information from the corresponding redundancy information to compensate for the corrupted pixel.

10. The method of claim 1, wherein the redundancy information is for a subset of the pixels in each of one or more data packets.

11. The method of claim 1, wherein the redundancy information is for all of the pixels in one or more data packets.

12. The method of claim 1, further comprising the step of placing the redundancy information in a redundancy packet, and transmitting the redundancy packet and other packets separately over a wireless channel.

13. The method of claim 1 wherein:
the step of partitioning the spatially correlated pixels further includes partitioning spatially correlated pixels into K different partitions;
the step of placing pixels from different partitions into different packets further includes copying the pixels of a subset of the partitions into different data packets, such that pixels with minimal spatial distance are essentially placed into different packets; and
the step of determining corresponding redundancy information further includes determining corresponding redundancy information for pixels in remaining partitions based on spatially correlated pixels in said packets.

14. The method of claim 13, wherein the step of copying includes selecting one or more pixels in every K pixels as redundancy information, instead of copying every pixel in a frame into packets.

15. The method of claim 13, wherein the redundancy information comprises an average value of every K pixels.

16. The method of claim 13 wherein:
the step of partitioning further includes partitioning spatially correlated pixels into K different partitions; and
the step of placing pixels from different partitions into different packets further includes selecting the value of the n^{th} pixel at every K pixel block as base information, wherein n<K, and for each block: placing the base information in a BASE packet as BASE pixels, encoding information of other pixels in the block as DIFF pixels, and placing the DIFF pixels in a DIFF packet.

17. The method of claim 16 wherein:
the BASE packet includes D bits of original pixel data per pixel as BASE pixels; and
the DIFF packet includes DIFF pixels, wherein each DIFF pixel includes D1 encoded bits and D2 bits of MSBs per BASE pixel as redundancy information for each BASE pixel, wherein D=D1+D2.

18. The method of claim 17, wherein the step of encoding further includes the step of performing DPCM encoding.

19. The method of claim 17, wherein the step of encoding further includes the step of performing bXOR encoding.

20. The method of claim 17, further comprising the step of, after encoding, eliminating zero MSBs of DIFF pixels.

21. The method of claim 20 further comprising the step of truncating the high order zero bits of the DIFF pixels.

22. The method of claim 17 further comprising the step of reordering bit order in each packet carrying the DIFF pixels and performing RLC for the re-ordered DIFF pixels.

23. The method of claim 16 wherein:
the BASE packet includes all bits of original pixel data per pixel as BASE pixels; and
the DIFF packet includes DIFF pixels and MSBs of one or more BASE pixels in the BASE packet as redundancy information for the BASE pixels.

24. The method of claim 13, wherein the redundancy information comprises FEC information.

25. The method of claim 13, wherein the redundancy information is for a subset of the pixels in the packets.

26. A wireless communication system comprising:
a wireless transmitter including:
a partitioning module that is configured to input uncompressed HD video pixels from a video frame and partition neighboring pixels into different partitions;
a packetization module that is configured to place the pixels from different partitions into different packets for transmission over a wireless channel; and
a redundancy information generator that is configured to determine corresponding redundancy information for one or more of the partitioned pixels based on spatially correlated pixels, for transmission over a wireless channel; and
a wireless receiver including:
an error detection module that is configured to check each received packet for corrupt pixels; and
an error recovery module that is configured to recover a corrupt pixel in a corrupt packet using the corresponding redundancy information.

27. The system of claim 26, wherein the redundancy information comprises a copy of said one or more pixels.

28. The system of claim 26, wherein the redundancy information comprises FEC information of one or more pixels.

29. The system of claim 26, wherein the corresponding redundancy information for a pixel comprises a copy of said pixel and the error recovery module is further configured to recover a corrupt pixel by copying a pixel from the corresponding redundancy information in place of the corrupt pixel.

30. The system of claim 26, wherein the corresponding redundancy information for a pixel comprises an average value of said pixel and neighboring pixels, and the error recovery module is further configured to recover a corrupt pixel using the average value from the corresponding redundancy information in place of the corrupt pixel information.

31. The system of claim 26, wherein the corresponding redundancy information for a pixel comprises FEC information for the pixel, and the error recovery module is further configured to recover a corrupt pixel using the FEC information from the corresponding redundancy information.

32. The system of claim 26, wherein the redundancy information is for a subset of the pixels in each of one or more data packets.

33. The system of claim 26, wherein the redundancy information is for all of the pixels in one or more data packets.

34. The system of claim 26, wherein the redundancy information generator is further configured to place the redundancy information in a redundancy packet for transmission over a wireless channel.

35. The system of claim 26, wherein:
the partitioning module is further configured to partition spatially correlated pixels into K different partitions;
the packetization module is further configured to copy the pixels of a subset of the partitions into different data packets, such that pixels with minimal spatial distance are essentially placed into different packets; and
the redundancy information generator is further configured to determine corresponding redundancy information for pixels in remaining partitions based on spatially correlated pixels in said packets.

36. The system of claim 35, wherein the packetization module is further configured to select one or more pixels in every K pixels as redundancy information.

37. The system of claim 35, wherein the redundancy information comprises an average value of every K pixels.

38. The system of claim 35, wherein:
the transmitter further includes an encoder;
the partitioning module is further configured to partition spatially correlated pixels into K different partitions; and
the packetization module is further configured to select the value of the n^{th} pixel at every K pixel block as base information, wherein n<K, and for each block place the base information in a BASE packet as BASE pixels, wherein the encoder is configured to encode information of other pixels in the block as DIFF pixels and place the DIFF pixels in a DIFF packet.

39. The system of claim 38, wherein:
the BASE packet includes D bits of original pixel data per pixel as BASE pixels; and
the DIFF packet includes DIFF pixels, wherein each DIFF pixel includes D1 encoded bits and D2 bits of MSBs per BASE pixel as redundancy information for each BASE pixel, wherein D=D1+D2.

40. The system of claim 39, wherein the encoder is further configured to perform DPCM encoding.

41. The system of claim 39, wherein the encoder is further configured to perform bXOR encoding.

42. The system of claim 39, wherein the encoder is further configured to eliminate zero MSBs of DIFF pixels.

43. The system of claim 42, wherein the encoder is further configured to truncate the high order zero bits of DIFF pixels.

44. The system of claim 39 wherein the encoder is further configured to reorder bit order in each packet carrying the DIFF pixels and perform RLC for the re-ordered DIFF pixels.

45. The system of claim 38 wherein:
the BASE packet includes all bits of original pixel data per pixel as BASE pixels; and
the DIFF packet includes DIFF pixels and MSBs of one or more BASE pixels in the BASE packet as redundancy information for the BASE pixels.

46. The system of claim 26, wherein the redundancy information comprises FEC information.

47. The system of claim 26, wherein the redundancy information is for a subset of the pixels in the packets.

48. A wireless transmitter comprising:
a partitioning module that is configured to input uncompressed video pixels from a video frame and partition neighboring pixels into different partitions;
a packetization module that is configured to place the pixels from different partitions into different packets for transmission over a wireless channel; and
a redundancy information generator that is configured to determine corresponding redundancy information for one or more of the partitioned pixels based on spatially correlated pixels, for transmission over a wireless channel.

49. The transmitter of claim 48, wherein the redundancy information comprises a copy of said one or more pixels.

50. The transmitter of claim 48, wherein the redundancy information comprises FEC information of one or more pixels.

51. The transmitter of claim 48, wherein the corresponding redundancy information for a pixel comprises a copy of said pixel.

52. The transmitter of claim 48, wherein the corresponding redundancy information for a pixel comprises an average value of said pixel and neighboring pixels.

53. The transmitter of claim 48, wherein the corresponding redundancy information for a pixel comprises FEC information for the pixel.

54. The transmitter of claim 48, wherein the redundancy information is for a subset of the pixels in each of one or more packets.

55. The transmitter of claim 48, wherein the redundancy information is for all of the pixels in one or more data packets.

56. The transmitter of claim 48, wherein the redundancy information generator is further configured to place the redundancy information in a redundancy packet for transmission over a wireless channel.

57. The transmitter of claim 48, wherein:
the partitioning module is further configured to partition spatially correlated pixels into K different partitions;
the packetization module is further configured to copy the pixels of a subset of the partitions into different data packets, such that pixels with minimal spatial distance are essentially placed into different packets; and
the redundancy information generator is further configured to determine corresponding redundancy information for pixels in remaining partitions based on spatially correlated pixels in said packets.

58. The transmitter of claim 57, wherein the packetization module is further configured to select one or more pixels in every K pixels as redundancy information.

59. The transmitter of claim 57, wherein the redundancy information comprises an average value of every K pixels.

60. The transmitter of claim 57, further including an encoder, wherein the partitioning module is further configured to partition spatially correlated pixels into K different partitions, and the packetization module is further configured to select the value of the n^{th} pixel at every K pixel block as base information, wherein n<K, and for each block place the base information in a BASE packet as BASE pixels, wherein the encoder is configured to encode information of other pixels in the block as DIFF pixels and place the DIFF pixels in a DIFF packet.

61. The transmitter of claim 60, wherein:
the BASE packet includes D bits of original pixel data per pixel as BASE pixels; and
the DIFF packet includes DIFF pixels, wherein each DIFF pixel includes D1 encoded bits and D2 bits of MSBs per BASE pixel as redundancy information for each BASE pixel, wherein D=D1+D2.

62. The transmitter of claim 61, wherein the encoder is further configured to perform DPCM encoding.

63. The transmitter of claim 61, wherein the encoder is further configured to perform bXOR encoding.

64. The transmitter of claim 61, wherein the encoder is further configured to eliminate zero MSBs of DIFF pixels.

65. The transmitter of claim 64, wherein the encoder is further configured to truncate the high order zero bits of DIFF pixels.

66. The transmitter of claim 61, wherein the encoder is further configured to perform RLC for the DIFF pixels and perform bit reordering in each packet to carry the DIFF pixels.

67. The transmitter of claim 60, wherein:
the BASE packet includes all bits of original pixel data per pixel as BASE pixels; and
the DIFF packet includes DIFF pixels and MSBs of one or more BASE pixels in the BASE packet as redundancy information for the BASE pixels.

68. The transmitter of claim 48, wherein the redundancy information comprises FEC information.

69. The transmitter of claim 48, wherein the redundancy information is for a subset of the pixels in the packets.

70. A wireless receiver comprising:
an error detection module that is configured to receive one or more packets including video pixels and check each received packet for corrupt pixels;
a redundancy handling module that is configured to receive one or more packets including redundancy information and extract redundancy information therefrom corresponding to said pixels; and
an error recovery module that is configured to recover a corrupt pixel in a corrupt packet using corresponding redundancy information.

71. The receiver of claim 70, wherein the redundancy information comprises a copy of said one or more pixels.

72. The receiver of claim 70, wherein the redundancy information comprises FEC information of one or more pixels.

73. The receiver of claim 70, wherein the corresponding redundancy information for a pixel comprises a copy of said pixel and the error recovery module is further configured to recover a corrupt pixel by copying a pixel from the corresponding redundancy information in place of the corrupt pixel.

74. The receiver of claim 70, wherein the corresponding redundancy information for a pixel comprises an average value of said pixel and neighboring pixels, and the error recovery module is further configured to recover a corrupt pixel using the average value from the corresponding redundancy information in place of the corrupt pixel information.

75. The receiver of claim 70, wherein the corresponding redundancy information for a pixel comprises FEC information for the pixel, and the error recovery module is further configured to recover a corrupt pixel using the FEC information from the corresponding redundancy information.

76. The receiver of claim 70, wherein the redundancy information is for a subset of the pixels in each of one or more data packets.

77. The receiver of claim 70, wherein the redundancy information is for all of the pixels in one or more data packets.

78. The receiver of claim 70, wherein the redundancy information is received in a redundancy packet separate from other packets.

79. The receiver of claim 70 wherein different packets include different spatially correlated pixels of an uncompressed video frame.

80. The receiver of claim 79 wherein the packets include video pixels that form partitions of spatially correlated pixels in the video frame.

81. The receiver of claim 80 further comprising a de-partitioning module that is configured to reconstruct the video frame partitions from the partitioned pixels in a plurality of received packets.

82. The receiver of claim 80, wherein:
the received packets include K partitions of spatially correlated pixels;
different data packets include copies of pixels of a subset of the partitions, such that pixels with minimal spatial distance are in different packets; and
the redundancy information corresponds to pixels in remaining partitions based on spatially correlated pixels in said packets.

83. The receiver of claim 82, wherein one or more pixels in every K pixels form the redundancy information.

84. The receiver of claim 82, wherein the redundancy information comprises an average value of every K pixels.

85. The receiver of claim 82, wherein:
in the received packets, spatially correlated pixels are partitioned into K different partitions, and the value of the n^{th} pixel at every K pixel block is selected as base information, wherein n<K, and for each block the base information is in a BASE packet as BASE pixels, wherein the information of other pixels in the block is encoded as DIFF pixels and placed in a DIFF packet.

86. The receiver of claim 85, wherein:
the BASE packet includes D bits of original pixel data per pixel as BASE pixels; and
the DIFF packet includes DIFF pixels, wherein each DIFF pixel includes D1 encoded bits and D2 bits of MSBs per BASE pixel as redundancy information for each BASE pixel, wherein D=D1+D2.

87. The receiver of claim 85 wherein:
the BASE packet includes all bits of original pixel data per pixel as BASE pixels; and
the DIFF packet includes DIFF pixels and MSBs of one or more BASE pixels in the BASE packet as redundancy information for the BASE pixels.

88. The receiver of claim 84 wherein the receiver further includes a decoder that is configured to decode encoded pixels in the received packets.
